(19) United States
(12) Patent Application Publication
(10) Pub. No.: US 2018/0063253 A1
(43) Pub. Date: Mar. 1, 2018

(54) METHOD, SYSTEM AND DEVICE FOR PROVIDING LIVE DATA STREAMS TO CONTENT-RENDERING DEVICES

(71) Applicant: TELEFONAKTIEBOLAGET LM ERICSSON (PUBL), Stockholm (SE)

(72) Inventors: Stefan HELLKVIST, Stockholm (SE); Tommy ARNGREN, Södra Sunderbyn (SE); Olof LUNDSTRÖM, Järfälla (SE)

(73) Assignee: TELEFONAKTIEBOLAGET LM ERICSSON (PUBL), Stockholm (SE)

(21) Appl. No.: 15/556,712

(22) PCT Filed: Mar. 9, 2015
(86) PCT No.: PCT/SE2015/050261

§ 371 Date: Sep. 8, 2017

(51) Int. Cl. H04L 29/08; H04N 21/218

(52) U.S. Cl. CPC H04L 67/141; H04L 67/22; H04N 21/25833; H04N 21/21805; H04L 67/306

(57) ABSTRACT

The invention relates to a network device (10), a system (100) and a method performed by the network device and the system for providing live data streams to content-rendering devices (12a-d). The invention further relates to a computer program (22), and a computer program product (21) comprising computer readable medium having the computer program stored thereon. The network device comprises a processing unit (20) and a memory, which memory contains instructions executable by the processing unit, whereby the network device is operative to monitor data identifying live data streams produced by at least one (13a) of a plurality of content-producing devices (13a-c), acquire at least one preference of a user of at least one of the content-rendering devices (12d), match the acquired user preference with the monitored data identifying produced live data streams, and establish at least one streaming session for the content-rendering device, with at least one communication device (13a, 15) distributing the produced live data streams matching the acquired at least one user preference, wherein the at least one content-rendering device may render the produced live data streams indicated by the acquired at least one user preference.

### TECHNICAL FIELD

The invention relates to a network device, a system and a method performed by the network device and the system for providing live data streams to content-rendering devices. The invention further relates to computer programs and computer program products comprising computer readable medium having the computer programs stored thereon.

### BACKGROUND

The World Wide Web is growing increasingly bigger every day and is used to an ever growing extent on a daily basis on different devices, such as smart phones, personal computers (PCs), tablets, IP-TV devices, etc. Mobile communication technologies facilitate capturing of audio visual content, and social networks and video sharing sites make it possible to share the content on the Internet. As communication technologies are developed and made more user-friendly, the sharing of audio visual content becomes more common. The amount of video traffic originating from mobile terminals is expected to increase.

Large arenas that are built today are equipped with wireless access technologies. Audiences typically bring their smart phones to the arenas, or other sites such as outdoor festivals where great events are held, and expect to be able to connect to social networks, and these events gathering massive audiences make it necessary to build special communication infrastructure to cater for the online access expected by the audiences. Current communication infrastructure at arenas is mainly dimensioned for online browsing (like Facebook/Twitter status updates) but is neither dimensioned nor technically prepared for simultaneous upload of high-definition (HD) content from a large number of smart phones using mobile applications like Facebook, YouTube, Twitter, Snapchat, etc., to share live experiences from events with friends and contacts by text using for instance Short Message Service (SMS), by photo using for instance Multimedia Message Service (MMS), or by video.

During the past 10-15 years, new ways of distributing video and television (TV) content has emerged, where Vimeo and YouTube are two well-known examples. YouTube (www.youtube.com, retrieved on 12 Jan. 2015) is a video-sharing website allowing users to upload, view, and share videos. Available content includes video clips, TV clips, music videos, and other content such as video blogging, etc. Key features of YouTube include playback and uploading. It is possible to embed YouTube videos in social networking pages and blogs. It is possible for users to rate and comment on videos, as well as to get recommendations about related videos to view. Before upload, a video can be tagged to increase the possibility to find it. However, it is not possible using YouTube to upload the video while it is being filmed, and hence not possible to dynamically add tags, rating or any other logic or processing to the clip as it is captured in a live setting.

YouTube has further introduced a content streaming concept referred to as “multiple camera angles”, where a user can select the camera angle she wants of an event from a series of thumbnails on a displayed video. However, the user has no possibility to customize a transmission in accordance with her own desires and requests in terms of the content to be transmitted.

### SUMMARY

An object of the present invention is to solve, or at least mitigate, this problem in the art and to provide a method and a device of providing live data streams to viewers for enabling improved usability.

This is attained in a first aspect of the invention by a method performed by a network device for providing live data streams to content-rendering devices. The method comprises monitoring data identifying live data streams produced by at least one of a plurality of content-producing devices, acquiring at least one preference of a user of at least one of the content-rendering devices, matching the acquired at least one user preference with the monitored data identifying produced live data streams, and establishing at least one streaming session for said at least one content-rendering device, with a communication device distributing the produced live data streams matching the acquired at least one user preference, wherein the at least one content-rendering device may render the produced live data streams indicated by the acquired at least one user preferences.

This is attained in a second aspect of the invention by a network device configured to provide live data streams to content-rendering devices, which comprises a processing unit and a memory, which memory contains instructions executable by the processing unit, whereby the network device is operative to monitor data identifying live data streams produced by at least one of a plurality of content-producing devices, acquire at least one preference of a user of at least one of the content-rendering devices, match the acquired at least one user preference with the monitored data identifying produced live data streams, and establish at least one streaming session for the at least one content-rendering device, with at least one communication device distributing the produced live data streams matching the acquired at least one user preference, wherein the at least one content-rendering device may render the produced live data streams indicated by the acquired at least one user preference.

This is attained in a third aspect of the invention by a method performed by a system for providing live data streams to content-rendering devices. The method comprises monitoring data identifying live data streams produced by at least one of a plurality of content-producing devices, acquiring at least one preference of a user of at least one of the content-rendering devices, matching the acquired at least one user preference with the monitored data identifying produced live data streams, and establishing at least one streaming session for said at least one content-rendering device, with a communication device distributing the produced live data streams matching the acquired at least one user preference, wherein the at least one content-rendering device may render the produced live data streams indicated by the acquired at least one user preferences.

This is attained by a fourth aspect by a system for providing live data streams to content-rendering devices. The system, which may comprise a plurality of network devices, comprises monitoring means for monitoring data identifying live data streams produced by at least one of a plurality of content-producing devices, acquiring means for acquiring at least one preference of a user of at least one of the content-rendering devices, matching means for matching the acquired at least one user preference with the monitored data identifying produced live data streams, and establishing means for establishing at least one streaming session for said at least one content-rendering device with at least one communication device distributing the produced live data streams matching the acquired at least one user preference, wherein the at least one content-rendering device may render the produced live data streams indicated by the acquired at least one user preference.

In an environment such as e.g. a sport event or arena concert, it can for instance be envisaged that people in an audience capture live videos with their User Equipment (UE), or that a television (TV) production team uses a number of cameras for covering the event, for instance by having a plurality of cameras stationed along a track of a cross-country skiing race to cover the race for television broadcast. The live videos captured by these content-producing devices, being for instance video cameras, mobile phones, tablets, etc., or any other suitable device being capable of capturing live video, may very well be of interest for other users for live rendering via a suitable content-rendering device such as a mobile phone, tablet, IPTV, laptop, embedded displaying device or head-up display in a vehicle etc. It can further be envisaged that a vehicle such as e.g. an Outside Broadcasting (OB) bus, i.e. a mobile remote broadcast TV studio covering the event in order to produce a TV broadcast, would want to have access to the captured live videos.

Typically at these events, it may exist hundreds or even thousands of devices potentially producing live content, and thousands or even millions of content-rendering devices e.g. taking part of the event in front of their IPTVs, tablets, smart phones or computer screens.

Thus, in an embodiment of the invention, if the captured live videos are tagged with data making it possible to identify the live videos being captured, it is possible for a user of a content-rendering device to select a particular type of live video that she wants to watch, i.e. based on at least one of her user preferences. As an example, at the cross-country skiing race previously mentioned, one or more users may wish to receive a TV transmission only focusing on skiers representing their country. For instance, a great number of Swedish users may wish to watch a TV transmission mainly focusing on Swedish skiers. Now, if a Swedish skier can be distinguished from a skier of any other nationality (which straightforwardly can be facilitated by means of a sensor attached to the respective skiers or even image processing distinguishing particular colours associated with the respective nationality), it is possible to tag the live videos captured of Swedish skiers with metadata identifying the skiers as being Swedish.

Advantageously, the network device according to an embodiment of the invention monitors the metadata identifying the captured live videos, and upon receiving a request from a user via a content-rendering device, being for instance a tablet, to render a particular live video stream, the network device matches one or more user preferences indicated in the request to the monitored metadata (the network device typically has access to a large amount of monitoring data associated with a great variety of captured live video streams). As a result of the matching of the user preferences comprised in the request with metadata addressing a particular type of live video stream, i.e. if there is correspondence between user preference and the metadata, the network device will establish a streaming session between the content-rendering device making the request and the content-producing device capturing the requested live video stream (or a centrally located device or storage to which the captured live video streams are transferred) as identified by the matching. In line with the example hereinabove, if the user preference would specify “Swedish” skiers, the network device will match the “Swedish” preference with a “Swedish” tag, and establish a streaming session accordingly.

In an embodiment of the invention, the network device establishes a plurality of streaming sessions via which the produced live data streams matching the acquired at least one user preference is distributed to the content-rendering device. Again, if the user preference would specify “Swedish” skiers, the network device will match the “Swedish” preference with a “Swedish” tag. However, it is likely that more than one content-producing device would capture live video streams matching the “Swedish” user preference, in which case the network device for instance will establish a first streaming session between the content-rendering device and a first content-producing device, a second streaming session between the content-rendering device and a second content-producing device, a third streaming session between the content-rendering device and a third content-producing device, and so on.

In a practical example, it can be envisaged that a maximum number of simultaneous session to be established is specified, either as a user preference or by the network device.

In a further embodiment, the matching is performed by the network device by considering a plurality of user preferences. For instance, a further user preference could specify a particular uphill slope which the skiers are to climb along the track. Thus, the network device will thus match the monitored metadata to the user preferences “Swedish” and “Track position Y” (indicating said uphill slope) and establish one or more streaming sessions with the content-rendering device to distribute live data streams fulfilling both these user preferences.

In still a further embodiment, the network device provides sorting data with the established streaming sessions for enabling sorting of the established streaming sessions at the content-rendering device in accordance with one or more sorting criteria. In case a great number of streaming sessions are established, potentially showing similar content as specified by the user preferences, the established sessions may be sorted on a screen of the user in a particular order by taking into account the sorting data, such as in order of ascending quality of the live video stream. This advantageously facilitates for the user to easier select which one (or more) of the live streams to render on her screen. It should be noted that the sorting criterion, in this case quality, may be selected by the user by specifying the sorting criterion as a user preference to be considered by the network device, but may alternatively be selected by the network device itself.

In an alternative embodiment, the network device actively fetches the user preferences from e.g. a database of a cloud-environment server (as predefined by for instance a particular subscription of the user) instead of receiving an explicit request from the content-rendering device of the user. A combination of the two is further possible, i.e. the user preferences to which a live video stream is matched by the network device is a combination of user preferences received in a request from the content-rendering device and user preferences fetched at the cloud server.

This will advantageously provide for an environment where custom-made transmission of live-produced content is facilitated, thereby giving the producers of content and viewers of content a unique opportunity to jointly create a live video rendering experience utilizing the capability of content-producing devices to provide live data streams to a great number of users by having the proposed network device provide particular live data streams to users by acquiring metadata associated with the live streams and matching the metadata to user requests. The metadata may be acquired by the network device either continuously as live data streams are being captured by the content-producing devices or upon request from a user wishing to render a particular live video stream. The acquired metadata may e.g. reside locally at the network device or in a cloud environment on for instance an application server depending on deployment of the network device.

The network device may be implemented in, or in connection to the arena, and be accessible via for instance a Wireless Local Area Network (WLAN), or it could alternatively be positioned remotely from the arena e.g. as an application server on the Internet. Numerous deployments can be envisaged for the network device and/or physical storage of acquired metadata.

In embodiments of the invention, the network device receives requests from a great number of content-rendering devices (or fetches a great number of sets of user preferences) to be matched with the appropriate metadata in order to establish streaming sessions with content-producing devices—or a central content-distributing device—for rendering requested live data streams, which streaming sessions are established between the content-rendering devices and the content-producing devices via one or more streaming session bridging devices, such as one or more Multipoint Control Units (MCUs). A streaming session bridging device is a device used for bridging multipoint connections, thereby facilitating interaction among users of the connections, such as for instance videoconference connections.

In a further embodiment, the network device dynamically monitors and controls the ongoing streaming sessions such that there is no mismatch between the user preferences and the live video streams supplied to the content-rendering devices. In this exemplifying embodiment, it is assumed that a first content-producing device, such as a mobile phone, captures live videos of a stage at the event which a user of content-rendering device, such as an IPTV, prefers to render. Hence, the captured live data is tagged “Stage” at the mobile phone, and the network device acquires the user preferences of the user of the IPTV, either by request or fetching as previously described. The user preferences to watch the stage is matched by the network device to the “Stage” metadata of the live video streams captured by the mobile phone, a streaming session is established accordingly, and the IPTV may render the produced “Stage” live streams indicated by the user preferences.

Now, it the user of the mobile phone e.g. stops filming the stage and instead starts filming herself, thereby causing the captured live video streams to be tagged “Selfie”, the produced video live streams intended to be provided to the IPTV will no longer match the acquired user preferences, as the user preferences stipulate “Stage” live streams and not “Selfie” live streams.

Thus, the network device advantageously monitors, on a continuous basis, whether the produced live data streams supplied to the IPTV in the established streaming session fails to satisfy the acquired user preferences. If so, the user will most likely not want to watch the supplied live data stream, and the network device disconnects the established streaming session for which the monitored metadata fails to satisfy the user preference(s), or notifies the content-rendering device that there is a mismatch.

In still a further embodiment, should the user wish to replace the streaming session for which there is a mismatch with a new session, the network device matches the acquired user preferences (“Stage”) with the monitored data of another one of the content-producing devices, for instance a second mobile phone, and establishes a new streaming session for rendering the produced live data streams matching the acquired user preferences with the second mobile phone.

The process of establishing a new streaming session with another one of the content-producing devices may also be undertaken in case the user preferences suddenly changes such that the live video stream rendered in a current streaming session no longer matches the user preferences.

It should be noted that the method according to the above described embodiments of the invention is exemplified as being performed by a single network device, but could alternatively be performed by a network system comprising a number of different devices interacting appropriately to perform the method.

Further provided are computer programs for causing a network device or a system to perform the method according to the invention, and computer program products comprising computer readable medium having the computer programs stored thereon.

Preferred embodiments of the invention will be described in the following.

It should be noted that by “live data stream” as discussed throughout the application is meant a data stream, such as a video or audio data stream, generated by a content-producing device and substantially instantly streamed after having been generated by the content-producing device, and received by the content-rendering device without substantial delay. With “substantial delay” is here meant that a certain delay most likely will occur in practice due to e.g. network transmission, network processing such as possible transcoding and possible very brief buffering of data in a network node and inherent delay caused by communication protocols. The substantial delay is here intended to be not more than 10 seconds, and preferably not more than 2 seconds.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a schematic overview of an exemplifying wireless communications network in which the network device according to an embodiment of the invention is deployed;

FIG. 2 shows a different deployment of the network device according to an embodiment of the invention;

FIG. 3 shows a simplified communications network implementing the network device according to an embodiment of the invention;

FIG. 4 shows a signaling diagram illustrating a method at the network device for providing live data streams in an embodiment of the invention;

FIG. 5 shows a simplified communications network implementing the network device in a further embodiment of the invention;

FIG. 6 shows a simplified communications network implementing the system in still a further embodiment of the invention;

FIG. 7 shows a simplified communications network implementing the network device according to still a further embodiment of the invention;

FIG. 8 shows a signaling diagram illustrating a method at the network device for providing live data streams in a further embodiment of the invention;

FIG. 9 shows establishing of a number of streaming sessions for providing the live data streams in accordance with an embodiment of the invention; and

FIG. 10 illustrates a system according to an embodiment of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

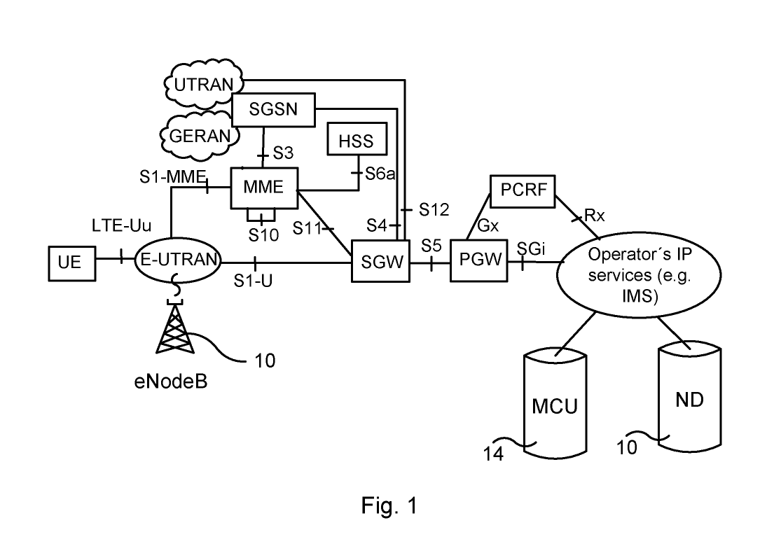

FIG. 1 shows a schematic overview of an exemplifying wireless communications network in which the invention may be deployed. The wireless communications network of FIG. 1 is a Long Term Evolution (LTE) based system. It should be pointed out that the terms “LTE” and “LTE based” are here used to comprise both and future LTE based networks, such as for example advanced LTE networks. It should be appreciated that although FIG. 1 shows an LTE based communications network, the example embodiments herein may also be utilized in connection with other wireless communications networks, such as, e.g., Global System for Communication (GSM) or Universal Mobile Telecommunications System (UMTS), comprising nodes and functions that correspond to the nodes and functions of the system in FIG. 1.

The wireless communications network comprises one or more base stations in the form of eNodeBs, operatively connected to a Serving Gateway (SGW), in turn operatively connected to a Mobility Management Entity (MME) and a Packet Data Network Gateway (PGW), which in turn is operatively connected to a Policy and Charging Rules Function (PCRF). The eNodeB is a radio access node that interfaces with a mobile terminal, e.g., a UE or an Access Point. The eNodeBs of the network form the so called Evolved Universal Terrestrial Radio Access Network (E-UTRAN) for communicating with the UE over an air interface, such as LTE-Uu. The core network in LTE is known as Evolved Packet Core (EPC), and the EPC together with the E-UTRAN is referred to as Evolved Packet System (EPS). The SGW routes and forwards user data packets over the S1-U interface, whilst also acting as the mobility anchor for the user plane during inter-eNodeB handovers and as the anchor for mobility between LTE and other 3rd Generation Partnership Project (3GPP) technologies (terminating S4 interface and relaying the traffic between 2G/3G systems and PGW). For idle state UEs, the SGW terminates the downlink data path and triggers paging when downlink data arrives for the UE, and further manages and stores UE contexts, e.g. parameters of the IP bearer service, network internal routing information. The SGW communicates with the MME via interface S11 and with the PGW via the S5 interface. Further, the SGW may communicate via the S12 interface with NodeBs of the Universal Terrestrial Radio Access Network (UTRAN) and with Base Station Transceivers (BTSs) of the GSM EDGE (“Enhanced Data rates for GSM Evolution”) Radio Access Network (GERAN).

The MME is responsible for idle mode UE tracking and paging procedure including retransmissions. It is involved in the bearer activation/deactivation process and is also responsible for choosing the SGW for a UE at the initial attach and at time of intra-LTE handover involving core network node relocation. It is responsible for authenticating the user by interacting with the Home Subscriber Server (HSS). The Non-Access Stratum (NAS) signaling terminates at the MME and it is also responsible for generation and allocation of temporary identities to UEs via the S1-MME interface. It checks the authorization of the UE to camp on the service provider's Public Land Mobile Network (PLMN) and enforces UE roaming restrictions. The MME is the termination point in the network for ciphering/integrity protection for NAS signaling and handles the security key management. The MME also provides the control plane function for mobility between LTE and 2G/3G access networks with the S3 interface terminating at the MME from the Serving General Packet Radio Service (GPRS) Support Node (SGSN). The MME also terminates the S3 interface towards the home HSS for roaming UEs. Further, there is an interface S10 configured for communication between MMEs for MME relocation and MME-to-MME information transfer.

The PGW provides connectivity to the UE to external packet data networks (PDNs) by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1X and EvDO). The interface between the PGW and the packet data network, being for instance the Internet, is referred to as the SGi. The packet data network may be an operator external public or private packet data network or an intra operator packet data network, e.g. for provision of IP Multimedia Subsystem (IMS) services.

The PCRF determines policy rules in real-time with respect to the radio terminals of the system. This may e.g. include aggregating information in real-time to and from the core network and operational support systems, etc. of the system so as to support the creation of rules and/or automatically making policy decisions for user radio terminals currently active in the system based on such rules or similar. The PCRF provides the PGW with such rules and/or policies or similar to be used by the acting PGW as a Policy and Charging Enforcement Function (PCEF) via interface Gx. The PCRF further communicates with the packet data network via the Rx interface.

A number of different placements can be envisaged for the network device (ND) 10 of embodiments of the invention, in the following being referred to as “managing device”. In FIG. 1, the managing device is placed as a node on the Internet, for instance in an application server where an MCU 14 also is placed, with which the managing device communicates in an embodiment of the invention.

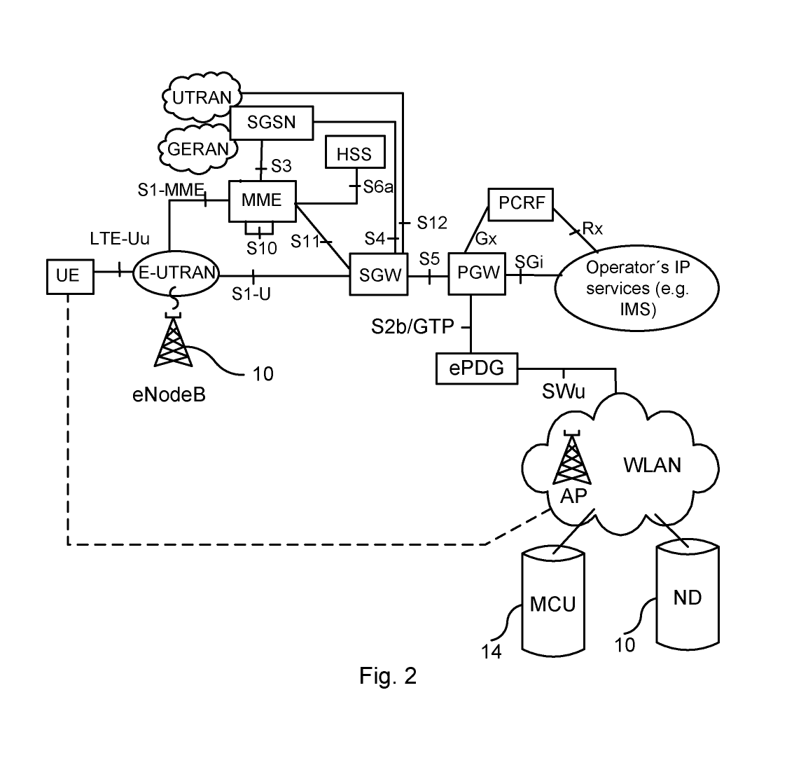

FIG. 2 illustrates a different placement of the managing device of embodiments of the invention, as well as of the MCU 14 with which the managing device may communicate. As can be seen, an Access Point (AP) hosting a Wireless Local Area Network (WLAN) has been added. The UE connects to the EPC network via interface SWu to an Evolved Packet Data Gateway (ePDG), in case of untrusted WLAN, and further via interface S2B/GTP to the PGW. In case of trusted WLAN (not shown in FIG. 2), the UE would instead connect to a Trusted Wireless Access Gateway (TWAG) via interface SWw and further via interface S2a/GTP. In the configuration of FIG. 2, an advantage is that a local cloud in the form of a WLAN can be setup at the arena with the managing device and the MCU also arranged locally, for instance in a so called Outside Broadcasting (OB) bus parked at the arena. In such a configuration, the latency between the UEs and the MCU(s) can be reduced when streaming data, and the load on the EPC network would decrease.

A combination of the configurations of FIGS. 1 and 2 can further be envisaged, where the managing device and the MCU 14 are arranged as devices on the Internet, but which devices are accessed by UEs via a local WLAN, and not via the E-UTRAN.

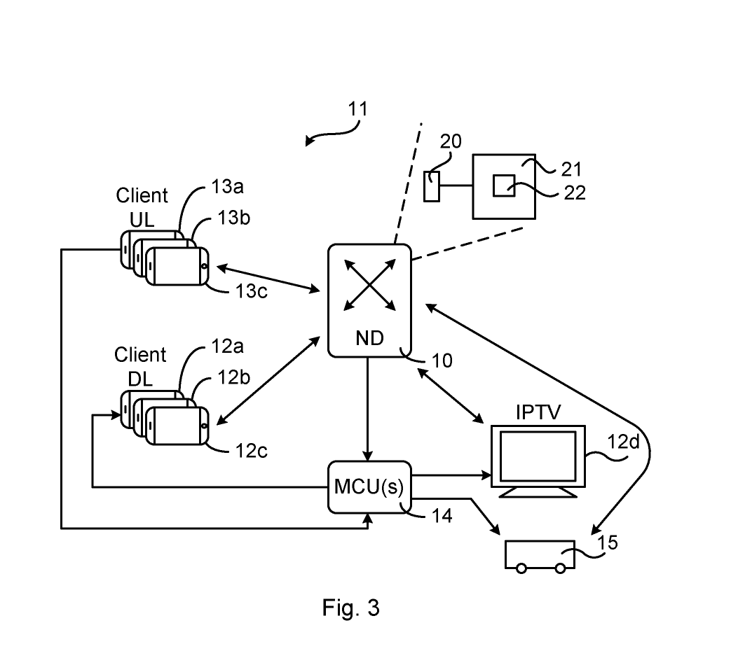

FIG. 3 shows a simplified communications network 11 implementing the network device 10 for providing live data streams to content-rendering devices 12a-c according to an embodiment of the invention. The network device 10 will be referred to as a “managing device”. The content-rendering devices 12a-c are downlink (DL) clients, such as mobile phones, held by users being part of the crowd at an event. A different type of content-rendering device is a DL client in the form of e.g. an IPTV 12d located remotely from the arena, potentially even in a different part of the world, for partaking in an event broadcast from the arena. As an example, the IPTV 12d may access the managing device and MCU 14 via E-UTRAN access as illustrated in FIG. 1, while the local DL clients 12a-c may perform the access via WLAN as illustrated in FIG. 2. It should be noted that the MCU(s) 14 may be omitted in the communications network 11, and that all data may pass via the managing device. However, for practical reasons, in order to handle a great number of streams at e.g. an arena event, it may be advantageous to have the managing device receive live data requests and establish streaming sessions via the MCU 14, while the MCU 14 handles the actual distribution of requested live data.

A DL client may also be embodied in the form of the previously mentioned OB bus 15, i.e. a mobile remote broadcast TV studio covering the event in order to produce a TV broadcast, which may want to render captured live videos for TV broadcast, or for viewing by the arena audience on a large-screen display or a jumbotron in the arena.

Further arranged in the communications network 11 are content-producing devices 13a-c which, such as mobile phones held by members of the audience or cameras used by an on-site TV production team, which captures live video streams of the event. These are uplink (UL) clients streaming requested data to the content-rendering devices 12a-12c via the MCU(s) 14 upon streaming session establishment effected by the managing device.

The managing device can, as was discussed in connection to FIGS. 1 and 2, be deployed either as part of the infrastructure in the arena or as part of a nearby local operator network. From a general point of view, availability of infrastructure inside or outside of the arena and operator coverage in the nearby surroundings as well as latency requirements will typically determine the most useful deployment.

The MCU(s) 14 serve as anchor points for setting up streaming sessions initiated by the managing device. A number of MCUs can be provided as virtual machines that can be scaled horizontally in a local cloud environment, but also scaled vertically by having one MCU handle more than one streaming session at a time. The MCU 14 can make use of broadcast functionality supported by available radio access, e.g. LTE Broadcast. As an alternative, the MCU 14 will setup multiple unicast connections.

A user may need to download an event specific application (“app”) related to the particular event to his/her UE, be it a concert, sports game, festival etc. The mobile app will make it possible to share live content streams in UL and consume live content streams in DL before, during, and after the event.

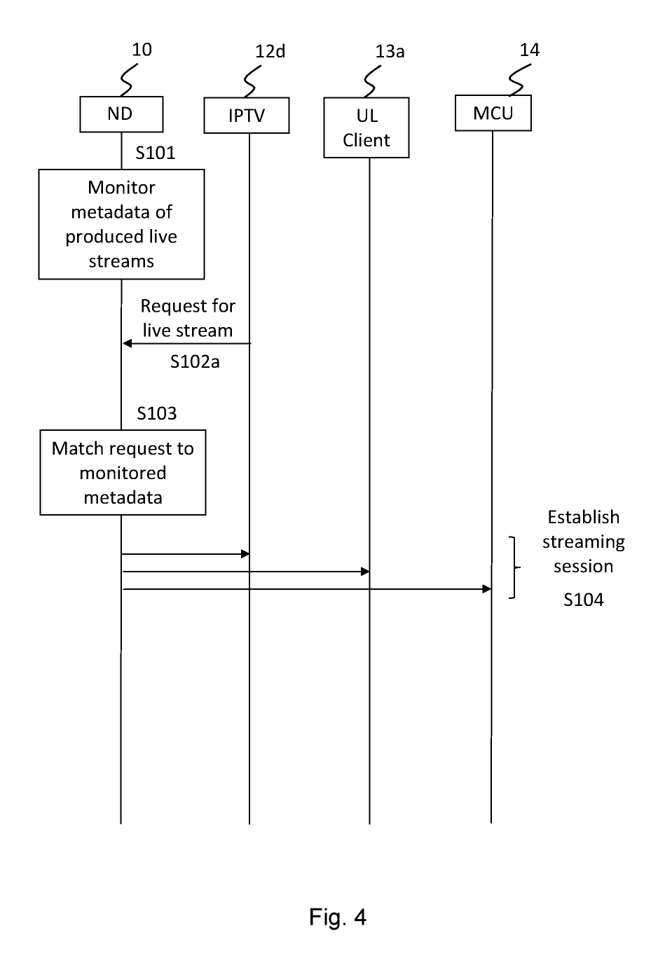

FIG. 4 shows a signalling diagram illustrating an embodiment of the method performed by the managing device for providing live data streams to content-rendering devices according to an embodiment of the invention. Reference is further made to FIG. 3 for structural elements. The embodiment will be described in the context of an exemplifying cross-country skiing event as previously discussed.

In practice, the method at the managing device is performed by a processing unit 20 embodied in the form of one or more microprocessors arranged to execute a computer program 22 downloaded to a suitable storage medium associated with the microprocessor, such as a Random Access Memory (RAM), a Flash memory or a hard disk drive, thereby forming a computer program product 21. The processing unit 20 is arranged to carry out the method according to embodiments of the invention when the appropriate computer program 22 comprising computer-executable instructions is downloaded to the storage medium and executed by the processing unit 20.

Alternatively, the computer program 22 may be transferred to the storage medium by means of a suitable computer program product 21, such as a Digital Versatile Disc (DVD) or a memory stick. As a further alternative, the computer program 22 may be downloaded to the storage medium over a network. The processing unit 20 may alternatively be embodied in the form of a digital signal processor (DSP), an application specific integrated circuit (ASIC), a field-programmable gate array (FPGA), a complex programmable logic device (CPLD), etc.

Thus, the content-producing devices 13a-c, i.e. the UL clients, in this case being TV cameras or UEs located along the ski track, continuously produce live data streams capturing the event from different physical locations along the track. The capture live data streams are tagged with appropriate metadata such that certain characteristics of the captured live data streams can be identified. For instance, live video streams capturing Swedish skiers may be tagged with the metadata “Swedish”, while live video streams capturing Finnish skiers may be tagged with the metadata “Finnish”, and so on.

The managing device monitors the metadata identifying the live data streams produced by the TV cameras 13a-c in step S101. The monitored data may e.g. be stored locally at the managing device, or at a server (not shown) in a cloud environment. The managing device should be capable of matching a given piece of metadata to a corresponding live data stream.

Now, a home viewer of the cross-country ski event watching the event via her IPTV 12d, i.e. a DL client, may have a preference for rendering captured live data streams showing mainly Swedish skiers. This could either be a pre-set preference for this particular viewer, or she may select the preference on-the-fly via her IPTV 12d. This preference results in a request being received by the managing device in step S102a to render live video streams in accordance with the viewer preferences, i.e. live video streams tagged with the “Swedish” metadata, for instance using GET requests in Hypertext Transfer Protocol (HTTP).

In response to the request received from the IPTV 12d, the managing device matches, in step S103, the received request with the monitored data identifying the requested live data streams. Hence, a match with metadata indicating “Swedish” skiers is performed, thereby identifying the UL client capturing the requested live data stream, in this case being exemplified by camera 13a (or a number of cameras).

Finally, in step S104, the managing device establishes, in a next available time slot, a streaming session between the IPTV 12d and the camera 13a having access to the requested live data stream. Thus, depending on implementation, the managing device may establish the streaming session by sending an instruction accordingly to any one or more of the IPTV 12d, the MCU 14 and the camera 13a. The instruction may be sent using any of e.g. HTTP, WebSocket or Session Initiation Protocol (SIP) signalling.

As soon as the IPTV 12d is assigned a channel for streaming, the managing device will appropriately handle signalling required to setup e.g. WebRTC (Web Real-Time Communication) streaming between the MCU 14 and the IPTV 12d and camera 13a. The managing device is aware of which (if many) MCU 14 is handling a respective stream so that a current MCU 14 can be notified and the session can be created.

The user preferences may e.g. be sent each time the IPTV submits a request to receive content, and may dynamically change with each submitted request, or for instance be sent once upon start of an app when the user participates in a particular event.

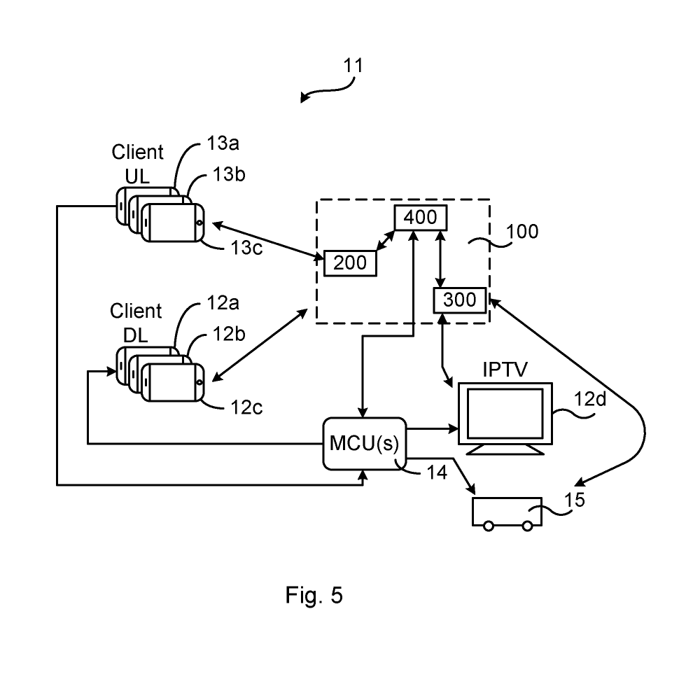

FIG. 5 shows a simplified communications network ii implementing a system 100 for providing live data streams to content-rendering devices 12a-c according to an embodiment of the invention. In this embodiment, instead of having a single network device 10 as illustrated in FIG. 3 performing the method of the invention, a system loo comprising a plurality of network devices, such as a first network device 200, a second network device 300 and a fourth network device 400, performs the method. Thus, the steps of the method of FIG. 4 are performed not by a single network device, but by the plurality of network devices 200, 300, 400.

In an exemplifying embodiment, the first network device 200 monitors the metadata identifying the live data streams produced by the TV cameras 13a-c in step S101. Further, the second network device 300 receives in step S102a a request to render live video streams in accordance with the preferences of the viewer of the IPTV 12d. In response to the request received from the IPTV 12d, the third network device 400 matches, in step S103, the received request with the monitored data identifying the requested live data streams. The third network device 400 thus needs to communicate with both the first network device 200 and the second network device 300 to attain the appropriate information for performing the match. Finally, in step S104, the fourth network device 400 establishes, in a next available time slot, a streaming session between the IPTV 12d and the camera 13a having access to the requested live data stream. Similar to the network device 10 of FIG. 3, each one of the network devices 200, 300, 400 comprises a processing unit embodied in the form of one or more microprocessors arranged to execute a computer program downloaded to a suitable storage medium associated with the microprocessor, thereby forming a computer program product.

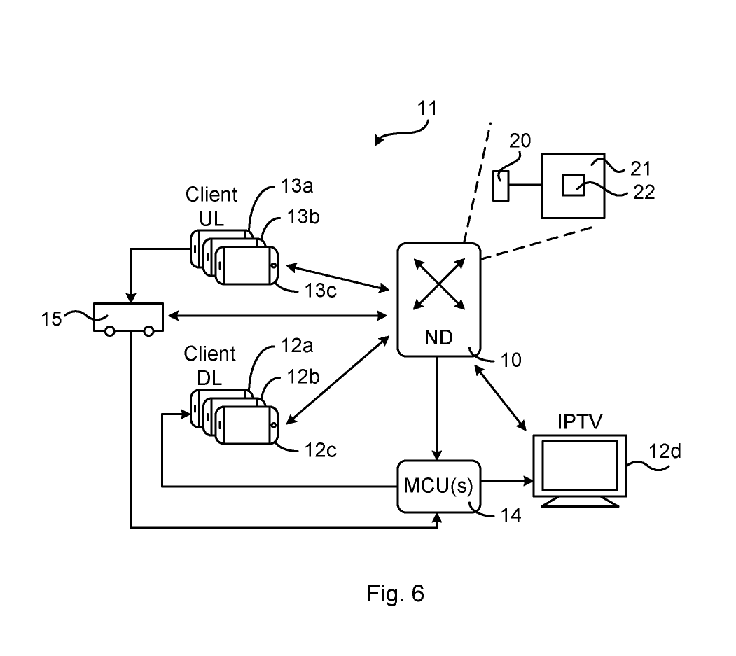

With reference to FIG. 6, in another embodiment of the invention, instead of establishing a streaming session between any one or more of the UL clients 13a-13c for having a content rendering device, such as the IPTV 12d, rendering requested live data streams via the MCU 14, an OB bus 15 could act as a buffer of video streams from the UL clients, possibly performing appropriate video editing. In such an embodiment, the managing device establishes, in a next available time slot, a streaming session in step S104 between the IPTV 12d and the OB bus 15 having access to the requested live data stream via one or more of the UL clients 13a-c. Thus, depending on implementation, the managing device may establish the streaming session by sending an instruction accordingly to any one or more of the IPTV 12d, the MCU 14 and the OB bus 15.

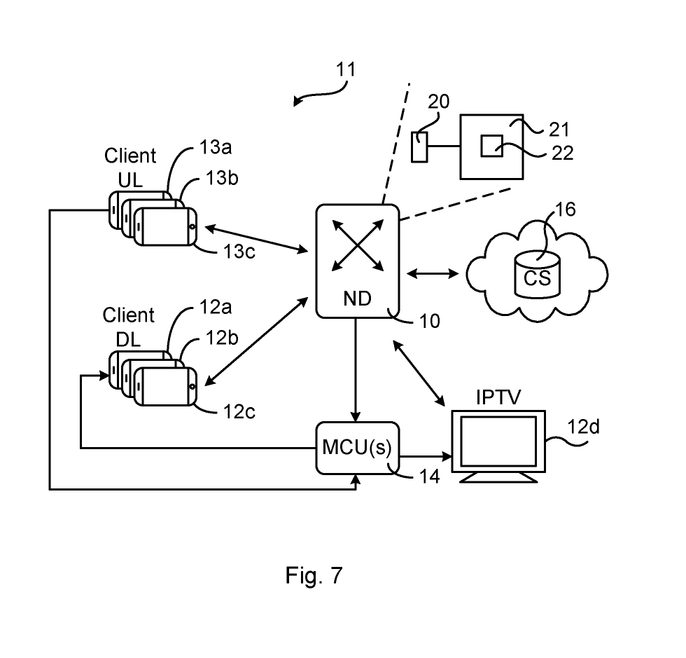

FIG. 7 illustrates a further embodiment of the invention, where a cloud server 16 is included in the communications network 11 for storing user preferences regarding which live streams a user of e.g. the IPTV 12d wishes to render.

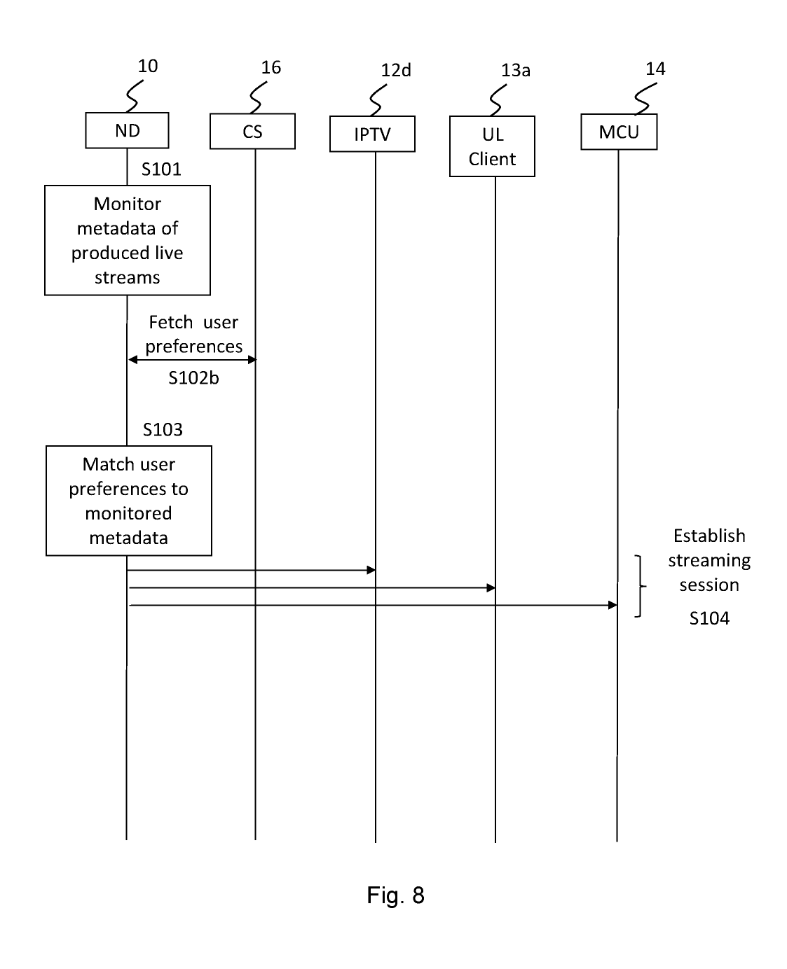

FIG. 8 shows a signalling diagram illustrating an embodiment of the method performed by the managing device for providing live data streams to content-rendering devices according to an embodiment of the invention. Reference is further made to FIG. 7 for structural elements. The embodiment will be described in the context of an exemplifying cross-country skiing event as previously discussed. The embodiment shown in FIG. 8 differs from that shown in FIG. 4 in that the managing device does not acquire the user preferences by receiving an explicit request from the IPTV 12d, but fetches predetermined user preferences stored in the cloud server 16.

Thus, the content-producing devices 13a-c, i.e. the UL clients, in this case being TV cameras or UEs located along the ski track, continuously produce live data streams capturing the event from different physical locations along the track. The capture live data streams are tagged with appropriate metadata such that certain characteristics of the captured live data streams can be identified.

The managing device monitors the metadata identifying the live data streams produced by the TV cameras 13a-c in step S101. The monitored data may e.g. be stored locally at the managing device, or at cloud server 16.

Now, the cloud server 16 further comprises user preference a home viewer of the cross-country ski event watching the event via her IPTV 12d, i.e. a DL client, which in this particular example has a preference for rendering captured live data streams showing mainly Swedish skiers. The managing device will thus fetch the user preferences from the cloud server 16 in step S012b. Again, any of e.g. HTTP, WebSocket or Session Initiation Protocol (SIP) signalling may be utilized.

After having fetched the user preferences from the cloud server 16 in step S102b, the managing device matches, in step S103, the user preferences with the monitored data identifying the preferred live data streams. Hence, a match with metadata indicating “Swedish” skiers is performed, thereby identifying the UL client capturing the requested live data stream, in this case being exemplified by camera 13a.

Finally, in step S104, the managing device establishes, in a next available time slot, a streaming session between the IPTV 12d and the camera 13a having access to the requested live data stream as indicated by the fetched user preferences. Thus, depending on implementation, the managing device may establish the streaming session by sending an instruction accordingly to any one or more of the IPTV 12d, the MCU 14 and the camera 13a (using e.g. HTTP, WebSocket or Session Initiation Protocol (SIP) signalling).

As soon as the IPTV 12d is assigned a channel for streaming, the managing device will appropriately handle signalling required to setup e.g. WebRTC streaming between the MCU 14 and the IPTV 12d and camera 13a. The managing device is aware of which (if many) MCU 14 is handling a respective stream so that a current MCU 14 can be notified and the session can be created.

Generally, the IPTV 12d sends a request to the managing device to set up a streaming session in line with user preferences of a viewer of the IPTV 12d, in response to which the managing device submits a session identifier or a “please hold” message in case there is currently no free capacity for establishing a new session. The IPTV 12d uses the session identifier to establish the streaming session by sending and receiving the appropriate set-up information in the form of for instance Session Description Protocol (SDP) files. The managing device selects which MCU should handle the session and routes the information to that particular MCU, whereupon the MCU responds to the managing device, which in its turn routes the information from the MCU to the IPTV 12d. When the SDP files have been exchanged, the IPTV 12d and the particular MCU are aware of each other and the live data streams can be submitted form an appropriate content-producing device via the particular MCU to the IPTV 12d.

In a further embodiment, the managing device dynamically monitors and controls the ongoing streaming sessions such that there is no mismatch between the user preferences and the live video streams supplied to the content-rendering devices.

Again with reference to FIG. 3, where the content-producing devices 13a-c (i.e. the UL clients) arranged in the communications network 11 are mobile phones held by members of the audience capturing live video streams of the event. Again it is assumed that a first UL client 13a captures live videos of a stage at the event which a user of DL client such as the IPTV 12d prefers to render. Hence, the captured live data is tagged “Stage” at the first UL client 13a, and the managing device acquires the user preferences of the user of the IPTV 12d, either by request or fetching as previously described. The user preferences to watch the stage is matched by the managing device to the “Stage” metadata of the live video streams captured by the first UL client 13a, a streaming session is established accordingly, and the IPTV 12d may render the produced “Stage” live streams indicated by the user preferences.

Now, it the user of the first UL client 13a e.g. stops filming the stage and instead starts filming herself, thereby causing the captured live video streams to be tagged “Selfie”, the produced video live streams intended to be provided to the IPTV 12d will no longer match the acquired user preferences, as the user preferences stipulate “Stage” live streams and not “Selfie” live streams.

Thus, the managing device advantageously (and continuously) monitors whether the produced live data streams supplied to the content-rendering devices, in this case IPTV 12d, in the established streaming session fails to satisfy the acquired user preferences. If so, the managing device matches the acquired user preferences (“Stage”) with the monitored data of another one of the content-producing devices, for instance a second UL client 13b, and establishes a new streaming session for rendering the produced live data streams matching the acquired user preferences with the second UL client 13b.

The process of establishing a new streaming session with another one of the UL clients will also be undertaken in case the user preferences suddenly changes such that the live video stream rendered in a current streaming session no longer matches the user preferences. The user preferences may, in addition to addressing particular type of live data streams to render, also stipulate user preferences being specific for a particular event. For instance, the user may have the same preferences when watching a football match every Sunday week after week, while having different preferences depending on e.g. a particular venue at which an event is held. Further, the user preferences may be based on historical data of a user, type of telephony/Internet service subscription, type of rendering device, type of ticket to, or seat at, an event, number of previously attended events for a particular event arranger desired video quality, service level, a rank of the user based on received “likes”, etc.

In still a further embodiment, the managing device submits one or more recommendations to the DL clients 12a-d based on the monitored data identifying live data streams produced by the UL clients 13a-c. Advantageously, a user of a DL client such as IPTV 12d is thus made aware of live content matching her preferences, and is thus given assistance in navigating and selecting relevant content among potentially a great number of live video streams.

In a further embodiment, the matching of the user preferences with the monitored data (i.e. the tags) identifying the produced live data streams is complemented by further taking into account preferences of a producer of the live data streams, such as e.g. quality (“high quality”, “medium quality”, “low quality”, etc.) of the produced live streams, a particular type of content that a producer would want to provide to one or more content-rendering-devices (e.g. content tagged as “selfie”, “fun”, “stage”, etc.), etc. The preferences of the producer could even be specified by using sensors arranged at the content-producing devices, such as accelerometers or light sensors, where a producer preference could stipulate that a live video stream only should be distributed if the content-producing device is kept relatively still in order to avoid distribution of blurred video streams, or for instance video streams filmed with inferior light conditions. In another example, the content-producer has specified the preference to only share live video streams with friends, in which case a content-rendering device belonging to a friend may be identified e.g. by means of an IP address of the content-rendering device. In such a scenario, even though the produced live stream matches the preferences of a user, the managing device will still not establish a streaming session with the content-rendering device of user unless the user is identified as a “friend”.

In the following, a number of examples will be given to illustrate the matching process that forms the basis for setting up one or more streaming sessions between one or content-producing devices and one or more content rendering device. It is envisaged that in practice, a plurality of user preferences can be used by the managing device for matching with the monitored data identifying produced live data streams, in order to establish one or more streaming sessions between a particular content-rendering device and one or more content producing devices.

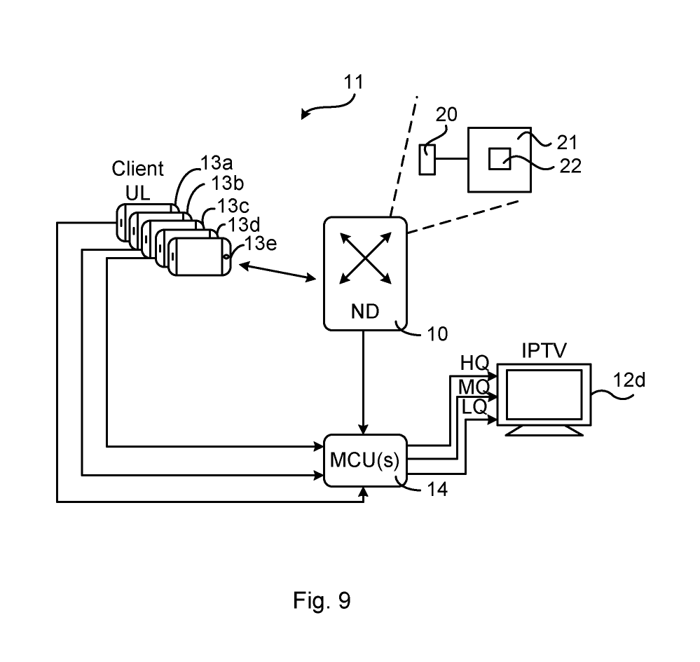

FIG. 9 illustrates a scenario where the user preferences of a user of the IPTV 12d are specified as following:

SHOW streams WHERE preference type=“stage” AND “distance_to_stage”<10 m AND “quality”>LQ AND “limit_of_streams”=3

Hence, the managing device acquires the above user preferences and matches the acquired preferences to the great amount of monitored metadata identifying the live data streams produced by the content-rendering devices in order to supply the user with desired content as specified by her user preferences.

As previously has been mentioned, at an event such as e.g. an arena concert, it may exist hundreds or even thousands of devices potentially producing live content, and thousands or even millions of content-rendering devices e.g. taking part of the event in front of their IPTVs, tablets or computer screens. FIG. 8 is used for illustrational purposes, and thus only shows one content-rendering device in the form of the IPTV 12d, and five content-producing devices 13a-e.

The acquired user preferences in this particular embodiment of the invention specifies that the user wishes to render live streams on her IPTV 12d, which all are tagged with metadata identifying the produced live streams
(1) as showing the stage,
(2) as being filmed on a distance from the stage of less than 10 m, and
(3) as having a quality being better than “low quality”

Further, the user does not want to have more than three simultaneously established streaming sessions satisfying the three above given user preferences.

The managing device will hence match user preferences (1)-(3) with the monitored metadata identifying produced live data streams. If the managing device finds three content-producing devices 13a-c out of the five content-producing devices 13a-e for which there is a match, the managing device establishes a streaming session with each one of the three content-rendering devices 13a-13c and the IPTV 12d via the MCU(s) 14. The user of the IPTV 12d may choose which one of the streaming sessions to render, or may even render all three simultaneously by using a picture-in-picture (PiP) feature on her IPTV 12d. Thus, out of the potentially enormous amount of live data produced at the arena concert possibly matching the user preferences of the viewer of the IPTV 12d, three streaming sessions are advantageously established by the managing device, thereby fulfilling the wishes of the viewer of the IPTV 12d.

As previously has been mentioned, in an embodiment of the invention, the managing device provides sorting data with the established streaming sessions for enabling sorting of the established streaming sessions at the IPTV 12d in accordance with one or more sorting criteria. For instance, a viewer of the IPTV 12d will see the established streaming sessions as thumbnails on the IPTV 12d, where the thumbnails has a respective quality indication and are sorted in order of ascending quality for the user to easily select the session with the highest quality. In this particular example, the established streaming sessions are considered to be of high quality (HQ), medium quality (MQ) and low quality (LQ), respectively.

Typically, the managing device will have to establish one or more streaming sessions with a second viewer based on the second viewer's preferences, one or more one or more streaming sessions with a third viewer based on the third viewer's preferences, and so on. Moreover, the streaming sessions of each of the viewers must typically be set up simultaneously.

In yet an exemplifying embodiment, an even more complex set of user preferences is considered by the managing device:

SHOW streams WHERE (preference type=“selfie” OR “dancing”) OR (preference type=“stage” AND “distance_to_stage <10 m) SORT BY brightness DESC, shakiness ASC

Thus, live streams tagged as “selfies” or “dancing” or being tagged as “stage” while at the same time being capture less than 10 m from the stage will match this particular set of user preferences.

In addition, the matching live video streams for which the managing device establishes streaming sessions with a content-rendering device will be sorted at the content-rendering device firstly in order of shakiness, where a less “shaky” stream for instance will be presented before a shakier stream on a list displayed on a screen of the content-rendering device. In case two or more streams are considered equally shaky, they are presented in order of brightness, where a brighter video is presented in the list before a darker video. Sorting data is thus provided with the established streaming sessions accordingly for enabling the user to straightforwardly select a live data stream to watch on the screen.

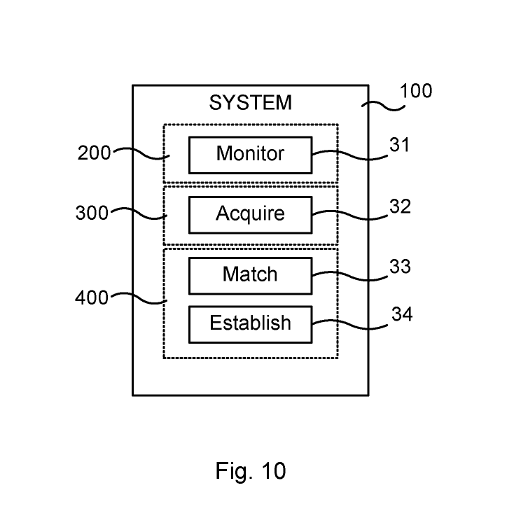

FIG. 10 shows a system 100 for providing live data streams to content-rendering devices according to an embodiment of the invention. The system may comprise a plurality of network devices, in this exemplifying embodiment a first network device 200, a second network device 300, and a third network device 400. The first network device 200 comprises monitoring means 31 adapted to monitor data identifying live data streams produced by at least one of a plurality of content-producing devices. The second network device 300 comprises acquiring means 32 adapted to acquire at least one preference of a user of at least one of the content-rendering devices. The third network device 400 comprises matching means 33 adapted to match the acquired at least one user preference with the monitored data identifying produced live data streams, and establishing means 34 adapted to establish at least one streaming session for the at least one content-rendering device, with at least one communication device distributing the produced live data streams matching the acquired at least one user preference, wherein the at least one content-rendering device may render the produced live data streams indicated by the acquired at least one user preference. The monitoring means 31, the acquiring means 32 and the establishing means 34 may comprise a communications interface for receiving and providing information, and further a local storage for storing data. The monitoring means 31, acquiring means 32, matching means 33 and establishing means 34 may (in analogy with the description given in connection to FIG. 3) be implemented by a processor embodied in the form of one or more microprocessors arranged to execute a computer program downloaded to a suitable storage medium associated with the microprocessor, such as a RAM, a Flash memory or a hard disk drive.

Again with reference to FIG. 10, a further embodiment of the system 100 for providing live data streams to content-rendering devices according to an embodiment of the invention is described. The system may comprise a plurality of network devices, in this exemplifying embodiment a first network device 200, a second network device 300, and a third network device 400. The first network device 200 comprises monitoring means 31 adapted to monitor data identifying live data streams produced by at least one of a plurality of content-producing devices. The second network device 300 comprises acquiring means 32 adapted to acquire at least one preference of a user of at least one of the content-rendering devices. The third network device 400 comprises matching means 33 adapted to match the acquired at least one user preference with the monitored data identifying produced live data streams, and establishing means 34 adapted to establish at least one streaming session for the at least one content-rendering device, with at least one communication device distributing the produced live data streams matching the acquired at least one user preference, wherein the at least one content-rendering device may render the produced live data streams indicated by the acquired at least one user preference. The monitoring means 31, the acquiring means 32 and the establishing means 34 may comprise a communications interface for receiving and providing information, and further a local storage for storing data. The monitoring means 31, acquiring means 32, matching means 33 and establishing means 34 may (in analogy with the description given in connection to FIG. 3) be implemented by a processor embodied in the form of one or more microprocessors, or in an ASIC of FPGA.

The invention has mainly been described above with reference to a few embodiments. However, as is readily appreciated by a person skilled in the art, other embodiments than the ones disclosed above are equally possible within the scope of the invention, as defined by the appended patent claims.

1-31. (canceled)

32. A method performed by a network device for providing live data streams, the method comprising:
monitoring data identifying live data streams produced by content-producing devices;
acquiring at least one preference of a user of a content-rendering device;
matching the acquired at least one user preference with the monitored data; and
establishing streaming sessions via which the produced live data streams of a plurality of content-producing devices matching the acquired at least one user preference are distributed to the content-rendering device, wherein the content-rendering device may render the produced live data streams indicated by the acquired at least one user preference.

33. The method of claim 32, further comprising:
providing sorting data with the established streaming sessions for enabling sorting of the established streaming sessions at the content-rendering device in accordance with one or more sorting criteria.

34. The method of claim 32, wherein the acquired at least one user preference comprises a plurality of user preferences.

35. The method of claim 32, wherein the matching of the acquired at least one user preference with the monitored data further comprises:
matching at least one content-producer preference with the monitored data identifying produced live data streams.

36. The method of claim 32, wherein the acquiring of the at least one user preference comprises:
receiving a request from the content-rendering device comprising the at least one user preference.

37. The method of claim 32, wherein the acquiring of the at least one user preference comprises:
fetching the at least one user preference from a database.

38. The method of claim 32, wherein the communication device distributing the requested live data stream is the content-producing device capturing the live data stream or a central content-distributing device having access to produced live data streams.

39. The method of claim 32, wherein the establishing of the streaming sessions comprises:
establishing the streaming sessions for the requesting content-rendering device via at least one streaming session bridging device with the plurality of content-producing devices.

40. The method of claim 32, further comprising:
monitoring whether the produced live data streams supplied to the content-rendering device in the established at least one streaming session fails to satisfy the acquired at least one user preference; and
disconnecting the established at least one streaming session for which the monitored data fails to satisfy the acquired at least one user preference.

41. The method of claim 32, further comprising:
monitoring whether the produced live data streams supplied to the content-rendering device in the established at least one streaming session fails to satisfy the acquired at least one user preference; and
notifying the at least one content rendering device that the monitored data of the produced live data streams supplied in the established at least one streaming session fails to satisfy the acquired at least one user preference.

42. The method of claim 40, further comprising:
matching the acquired at least one user preferences with the monitored data of another one of the content-producing devices; and
establishing a new streaming session for rendering the produced live data streams matching the acquired at least one user preferences with said another one of the content-producing devices.

43. The method of claim 32, wherein the matching of the acquired at least one user preference with the monitored data identifying produced live data streams comprises:
comparing the acquired at least one user preference with the monitored data, wherein the monitored data is considered to match the user preference in case the live data streams identified by the monitored data corresponds to type of live data stream requested with the acquired at least one user preference.

44. A method performed by a system for providing live data streams, the method comprising:
monitoring data identifying live data streams produced by content-producing devices;
acquiring at least one preference of a user of a content-rendering device;
matching the acquired at least one user preference with the monitored data; and
establishing streaming sessions via which the produced live data streams of a plurality of content-producing devices matching the acquired at least one user preference are distributed to the content-rendering device, wherein the content-rendering device may render the produced live data streams indicated by the acquired at least one user preference.

45. A network device configured to provide live data streams, the network device comprising:
a processing unit; and
a memory, said memory containing instructions executable by said processing unit, wherein said network device is operative to:
monitor data identifying live data streams produced by content-producing devices;
acquire at least one preference of a user of a content-rendering device;
match the acquired at least one user preference with the monitored data; and
establishing streaming sessions via which the produced live data streams of a plurality of content-producing devices matching the acquired at least one user preference are distributed to the content-rendering device, wherein the content-rendering device may render the produced live data streams indicated by the acquired at least one user preference.

46. The network device of claim 45, further being operative to:
provide sorting data with the established streaming sessions for enabling sorting of the established streaming sessions at the content-rendering device in accordance with one or more sorting criteria.

47. The network device of claim 45, wherein the acquired at least one user preference comprises a plurality of user preferences.

48. The network device of claim 45, further being operative to:
match at least one content-producer preference with the monitored data identifying produced live data streams.

49. The network device of claim 45, further being operative to, when acquiring the at least one user preference:
receive a request from the content-rendering device comprising the at least one user preference.

50. The network device of claim 45, further being operative to, when acquiring the at least one user preference: fetch the at least one user preference from a database.

51. The network device of claim 45, further being operative to, when establishing the streaming sessions: establish the streaming sessions for the requesting content-rendering device via at least one streaming session bridging device with the plurality of content-producing devices.

52. The network device of claim 45, further being operative to:
monitor whether at least one of the produced live data streams supplied to the content-rendering device in the established streaming sessions fails to satisfy the acquired at least one user preference; and
disconnect the at least one streaming session for which the monitored data fails to satisfy the acquired at least one user preference.

53. The network device of claim 45, further being operative to:
monitor whether at least one of the produced live data streams supplied to the content-rendering device in the established streaming sessions fails to satisfy the acquired at least one user preference; and if so
notify the at least one content rendering device (12d) that the monitored data for the at least one of the produced live data streams supplied in the established at least one streaming session fails to satisfy the acquired at least one user preference.

54. The network device of claim 52, further being operative to:
match the acquired at least one user preferences with the monitored data of another one of the content-producing devices; and
establish a new streaming session for rendering the produced live data streams matching the acquired at least one user preferences with said another one of the content-producing devices.

55. The network device of claim 45, being operative to, when matching the acquired at least one user preference with the monitored data identifying produced live data streams:
compare the acquired at least one user preference with the monitored data, wherein the monitored data is considered to match the at least one user preference in case the live data streams identified by the monitored data corresponds to content type requested with the acquired at least one user preference.

56. A computer program product comprising a non-transitory computer readable medium having a computer program stored thereon, said computer program comprising computer-executable instructions which when run on a system or a network device for providing live data streams, causes the system or the network device to:
monitor data identifying live data streams produced by at least one of a plurality of content-producing devices;
acquire at least one preference of a user of a content-rendering device;
match the acquired at least one user preference with the monitored data identifying produced live data streams; and
establishing streaming sessions via which the produced live data streams of a plurality of content-producing devices matching the acquired at least one user preference are distributed to the content-rendering device, wherein the content-rendering device may render the produced live data streams indicated by the acquired at least one user preference.
